(19) United States
(12) Patent Application Publication
(10) Pub. No.: US 2014/0051815 A1
(43) Pub. Date: Feb. 20, 2014

(54) ORGANIC SULFONIC ACID COMPOUND, DOPANT HAVING SAME, AND CONDUCTIVE POLYMER COMPLEX HAVING THE DOPANT

(71) Applicant: Ajou University Industry-Academic Cooperation Foundation, Suwon-si (KR)

(72) Inventors: Suck Hyun Lee, Gwacheon-si (KR); O Pil Kwon, Suwon-si (KR); Tae Ja Kim, Siheung-si (KR)

(73) Assignee: Ajou University Industry-Academic Cooperation Foundation, Suwon-si (KR)

(21) Appl. No.: 14/063,864

(22) Filed: Oct. 25, 2013

Related U.S. Application Data
(63) Continuation of application No. PCT/KR2012/003114, filed on Apr. 23, 2012.

(30) Foreign Application Priority Data
Apr. 25, 2011 (KR) 10-2011-0038650

(51) Int. Cl. H01B 1/12

(52) U.S. Cl. CPC H01B 1/128
USPC 525/540; 562/42; 252/182.17

(57) ABSTRACT

The present disclosure relates to an organic sulfonic acid-based compound and a preparation method thereof, a dopant including the compound, and a conductive polymer composite including the dopant, and more specifically, provides a dopant including a derivative compound containing a sulfonic acid group connected to a benzene ring via a flexible chain to enhance the solubility and the dispersibility in a general solvent, and the environment-resistance thereof, thus increasing the electric conductivity and significantly improving not only the processability but also the mechanical feature.

### CROSS-REFERENCE TO RELATED APPLICATIONS

This application is a continuation of International Application No. PCT/KR2012/003114 filed on Apr. 23, 2012, claiming priority based on Korean Patent Application No. 10-2011-0038650 filed on Apr. 25, 2011, the contents of all of which are incorporated herein by reference in their entirety.

### TECHNICAL FIELD

The present disclosure relates to a novel organic sulfonic acid-based compound, a dopant including the organic sulfonic acid-based compound, and a conductive polymer composite including the dopant.

### BACKGROUND ART

Conjugated polymers having a structure in which a double bond is alternately crosslinked to a single bond have attracted much attention. All of such conjugated polymers have conductive or semiconductive properties since π-electrons involved in the double bond serve as carriers that transfer charges. Thus, the conjugated polymers can be used as key materials in the era of photoelectronic engineering. Main conductive polymers known so far include polyaniline, polypyrrole, polythiophene, poly(p-phenylene vinylene), poly(p-phenylene), and polyphenylene sulfide (PPS). Such conductive polymers can be used depending on their conductivity for antistatic materials at a conductivity of from 10⁻¹³ S/cm to 10⁻⁷ S/cm, static discharge materials at a conductivity of from 10⁻⁶ S/cm to 10⁻² S/cm, and EMI shielding materials, battery electrodes, semiconductors, or solar cells at a conductivity of 1 S/cm or more. If their conductivity is improved, the conductive polymers can be developed into further high-tech applications including transparent electrodes and the like.

Polythiophenes have been commercialized and widely used as poly(3,4-ethylenedioxythiophene (PEDOT) (EP Patent No. 339 340) having a substituent in a thiophene ring. A chemical structure of the polythiophene is as shown below:

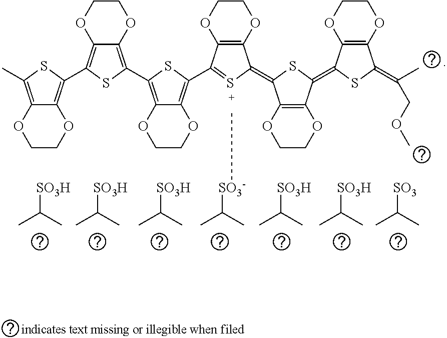

Polyanilines are organic polymers having an alternating ring heteroatom backbone structure in which various substituents can be introduced to a benzene ring or a nitrogen atom, and can be classified depending on their oxidation state into a partially oxidized Emeraldine Base (EB) (y=0.5), a fully reduced Leucoemeraldine Base (LE) (y=1.0), and a fully oxidized Pernigraniline Base (PN) (y=0.0) as shown in the following chemical structures.

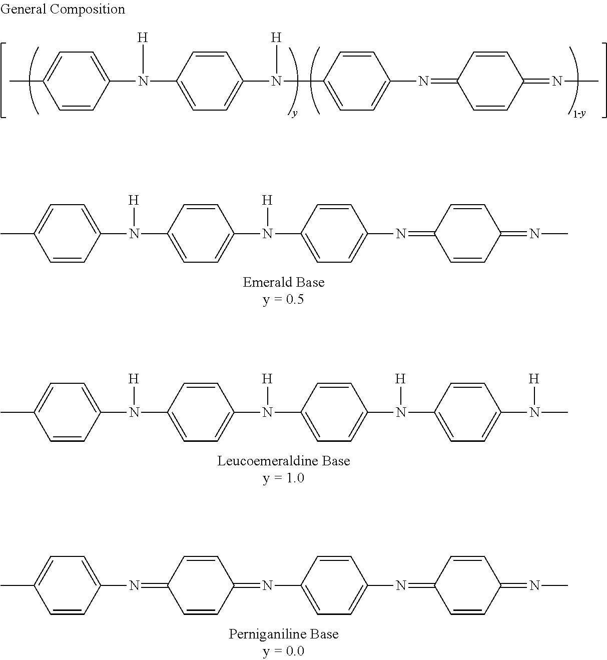

These conductive polymers can be doped and dedoped through an acid-base reaction in addition to an electric method. In particular, conductivity of polyaniline can be adjusted by using such an acid-base reaction and thus has been widely used. However, a kind of an acid may highly affect not only conductivity but also heat-resistant and environment-resistant stability. The polyaniline has two nitrogen atom groups in the backbone, and pKa values of the groups (—NH₂⁺—) and (—NH⁺═) are 2.5 and 5.5, respectively. Therefore, a strong acid having a pKa<2.5 may donate protons to these two groups and can dope the polyaniline. An imine nitrogen atom of the latter can be fully or partially protonated in a protonic acid aqueous solution. In this case, it becomes Emeraldine Salts (ES) of which a doping level can be adjusted, and conductivity of the ES in the forms of a powder and a film is sharply increased from 10⁻⁸ S/cm to 1˜1000 S/cm. Such a doping process has been well understood through numerous studies, and it is well known to be largely divided into primary doping and secondary doping using phenols solvent, etc. as suggested by MacDiarmid et al. in U.S. Pat. No. 5,403,913. According to a method for doping by changing a counter ion of a sulfonic acid dopant suggested by Cao et al. in U.S. Pat. No. 5,232,631 as the most noteworthy method, solubility of a conductive polymer composite in an organic solvent is increased and processability is increased. By way of example, if CSA as a functional organic acid disclosed by Cao et al. in U.S. Pat. No. 5,232,631 is used as a dopant of polyaniline, ES/CSA is sufficiently dissolved in an organic solvent such as meta-cresol, and, thus, solution casting can be carried out. However, with a low molecular weight (intrinsic viscosity of from 0.8 dl/g to 1.2 dl/g), polyaniline can be dissolved in 1-methyl-2-pyrrolidone (NMP), and emeraldine salts doped with 10-camphorsulfonic acid (ES/CSA) can be dissolved in meta-cresol but can become gel at room temperature. Further, even if a conductive polymer blend is manufactured by using a relatively macromolecular organic acid such as dodecylbenzensulfonic acid (DBSA), acrylamidomethylsulfonic acid (2-acrylamido-2-methyl-1-propanesulfonic acid, AMPSA), camphorsulfonic acid (CSA), there is still a problem with environment-resistance or heat-resistance. In particular, as for a polyaniline product in the form of a thin film, a decrease in conductivity caused by loss of a dopant in the air is an important issue.

M. Jayakannan et al. (US Patent Application No. US2009/0314995) and Paul et al. (U.S. Pat. No. 6,552,107) describe a method of preparing a cardanol-based derivative to be used as a dopant. According to each of them, an azo sulfonic acid derivative and a 3-pentadecyl phenol derivative are main structures of dopants, and a hydroxyl group and an alkyl side chain are introduced thereto, and, thus, solubility is increased along with regeneration potential using a cashew nut shell as a natural substance. However, an azo group can be thermally denaturalized and an alkyl group as a side chain is not well defined and a double bond may exist. Thus, chemical and physical characteristics can be changed. Further, there is also disclosed a regenerable lignosulfonic acid-based dopant (U.S. Pat. Nos. 5,968,417, 6,299,800, 6764617, etc.). However, most of the above-described dopants have electrical conductivity, as a main characteristic, as low as 10⁻³ S/cm, and, thus, there is a limit in effectively using it.

Meanwhile, according to a document of Ikkala et al. (Ikkala O T, Laakso J, Vakiparta K, Virtanen E, Ruohonen H, Jarvinen H, Ahjopalo L, Osterholm J E. Synth Met 1997; 84: pp 55), by using molecular recognition (charge transfer, benzene ring overlap, hydrogen bond), a structure and form of a polymer is changed to improve solubility and conductivity and obtain stability. By way of example, with respect to organic solvent of a functional organic acid CSA, and a meta-cresol as disclosed by Cao et al. in U.S. Pat. No. 5,232,631, it is reported in a document [Olli T. Ikkala et. al., J. Chem. Phys. 1995; vol. 103, Issue 22, pp. 9855] of Ikkala et al. that van der waals attractive forces occurring when a polyaniline benzene ring is overlapped with a meta-cresol benzene ring is caused by a hydrogen bond between a carbonyl group of the CSA and a hydroxyl group of the meta-cresol. As an optimum structure of polyaniline/CSA dissolved in the meta-cresol, a structure A shows that a hydroxyl group of the meta-cresol forms a hydrogen bond with —SO₃ of the sulfonic acid and a structure B shows that a hydroxyl group of the meta-cresol forms a hydrogen bond with a carbonyl group of the CSA. The structure B induces an overlap of the two benzene rings.

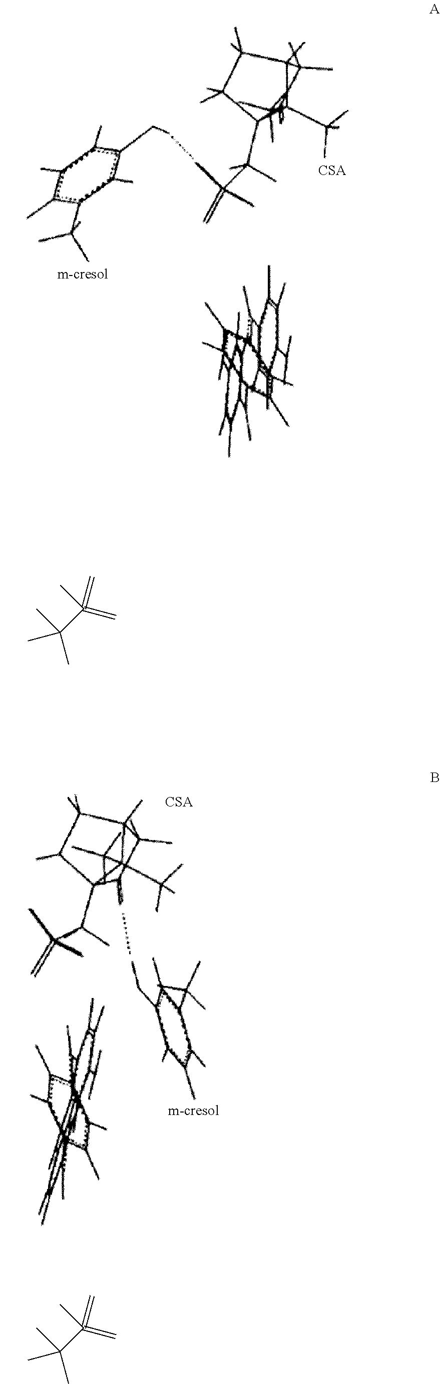

However, various conventional dopants for conductive polymers still have the above-described problems in terms of solubility, dispersibility, an environment-resistance, processability, a mechanical property, and the like and need to be improved.

### DISCLOSURE OF THE INVENTION

### Problems to be Solved by the Invention

In view of the foregoing, an objective of the present disclosure is to provide an organic sulfonic acid-based compound in which an aryl ring such as a benzene ring having a substituent is bonded to a sulfonic acid by a flexible chain, a dopant including the organic sulfonic acid-based compound, a conductive polymer composite including the dopant and a conductive polymer, and a preparing method of the conductive polymer composite.

However, problems to be solved by the present disclosure are not limited to the above-described problems. Although not described herein, other problems to be solved by the present disclosure can be clearly understood by those skilled in the art from the following descriptions.

### Means for Solving the Problems

In order to achieve the objective, in accordance with a first aspect of the present disclosure, there is provided an organic sulfonic acid-based compound in which an aryl group having a substituent is bonded by a flexible hydrocarbon chain, represented by the following Chemical Formula 1:

Ar(R₃)(R₂)O—R₁—SO₃Z; [Chemical Formula 1]

wherein in Chemical Formula 1,

Ar represents an aryl group,

R₁ represents C₁-C₂₀ alkyl, C₂-C₂₀ alkenyl, halo-C₁-C₂₀ alkyl, halo-C₂-C₂₀ alkenyl, or —(CH₂CH₂O)ₙ,

R₂ and R₃ are independently selected from —H, —OH, —CH₃, —C₆H₅, —C₆H₄OCH₃, —OCH₂C₆H₅, C₁-C₂₀ alkyl, C₂-C₂₀ alkenyl, halo-C₁-C₂₀ alkyl, halo-C₂-C₂₀ alkenyl, and —(CH₂CH₂O)ₙ, respectively, provided that R₂ and R₃ are not —H at the same time,

Z represents —H or a metal cation M⁺, and if Z is M⁺, the organic sulfonic acid-based compound has a salt form represented by Ar(R₃)(R₂)O—R₁—SO₃⁻M⁺, and

n represents an integer of 1 or more.

In accordance with another aspect of the present disclosure, there is provided a dopant including an organic sulfonic acid-based compound in accordance with the present disclosure. In the dopant, the organic sulfonic acid-based compound may include a sulfonic acid form, a metallic salt form of a sulfonic acid, or a mixture of the sulfonic acid form with the a metallic salt form of the sulfonic acid, but the present disclosure may not be limited thereto.

In accordance with still another aspect of the present disclosure, there is provided a conductive polymer composite, including: a dopant and a conductive polymer in accordance with the present disclosure.

In accordance with still another aspect of the present disclosure, there is provided a preparing method of the conductive polymer composite in accordance with the present disclosure.

### Effects of the Invention

According to the present disclosure, a novel organic sulfonic acid-based compound containing an aryl group having various substituents such as a hydroxyl group in addition to hydrogen atoms can be used as a bi-functional dopant having a function as a dopant of a conductive polymer and a function of molecular recognition. To be specific, if the novel organic sulfonic acid-based compound of the present disclosure is used as a dopant of a conductive polymer, an oxygen atom bonded to the aryl group contained in the organic sulfonic acid-based compound is bonded to a sulfonic acid group or a sulfonic acid anion by a flexible hydrocarbon chain, and, thus, doping efficiency can be increased, and substitution of other substituents bonded to an aniline ring such as a benzene ring, a length of the substituent, and a relative ratio of a sulfonic acid and its metallic salt can be regulated, and, thus, the dopant can react with a conductive polymer in various ways so as to prepare a conductive polymer composite having excellent compatibility, an environment-resistance, conductivity, and a mechanical property. In particular, as compared with conventional dopants, the novel organic sulfonic acid-based compound of the present disclosure is constructed based on an interaction or mutual perception between a conductive polymer to be added as a dopant with a molecule and formation of a mesophase of a conjugate base. Therefore, a dopant containing the organic sulfonic acid-based compound of the present disclosure has improved solubility and compatibility with respect to a conductive polymer and can provide a conductive polymer composite having an excellent mechanical property and electrical conductivity of about 10³ S/cm, and since the dopant is stable at a processing temperature of about 200° C. or more, it can be used to manufacture various conductive polymer composite products processed to be in the form of a thin film, a fiber, and the like or in a solution state or a molten state with improved processability and environment-resistance.

Further, a blend may be prepared to improve functions by mixing a conductive polymer with an additional second polymer. In this case, a dopant design may have different effects between the case of selecting a substituent which can be mixed with the second polymer well and the case of selecting a substituent which is not mixed at all. If the conductive polymer is blended with a molecular second polymer which is mixed well, dispersibility can be increased and structural uniformity can be maintained. If a second polymer which is not mixed well is selected, even if only a conductive polymer composite sufficient to form a continuous phase is used, high conductivity can be obtained, and, thus, it can be expected to have double effect of high conductivity at a small amount.

### BRIEF DESCRIPTION OF THE DRAWINGS

FIG. 1 illustrates a sample of an organic sulfonic acid-based compound of the present disclosure;

FIGS. 2A and 2B show an IR analysis result of organic sulfonic acid-based compounds (dopants I to III) of the present disclosure and an IR analysis result of organic sulfonic acid-based compounds (dopants IV to VI) of the present disclosure, respectively;

FIGS. 3A and 3B show a DSC analysis result of organic sulfonic acid-based compounds (dopants I to III) of the present disclosure and a DSC analysis result of organic sulfonic acid-based compounds (dopants IV to VI) of the present disclosure, respectively; and

FIGS. 4A and 4B show a TGA analysis result of organic sulfonic acid-based compounds (dopants I to III) of the present disclosure and a TGA analysis result of organic sulfonic acid-based compounds (dopants IV to VI) of the present disclosure, respectively.

### BEST MODE FOR CARRYING OUT THE INVENTION

Hereinafter, illustrative embodiments and examples of the present disclosure will be described in detail with reference to the accompanying drawings so that the present disclosure may be readily implemented by those skilled in the art.

However, it is to be noted that the present disclosure is not limited to the illustrative embodiments and examples but can be embodied in various other ways. In drawings, parts irrelevant to the description are omitted for the simplicity of explanation, and like reference numerals denote like parts through the present disclosure.

Through the present disclosure, the term “comprise or include” and/or “comprising or including” used in the document means that one or more other components, steps, operation and/or existence or addition of elements are not excluded in addition to the described components, steps, operation and/or elements unless context dictates otherwise.

The term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party. Through the present disclosure, the term “step of” does not mean “step for”.

Through the present disclosure, the term “alkyl”, alone or as a part of another group, includes linear or branched radicals having from 1 to 22 carbon atoms, from 1 to 20 carbon atoms, from 1 to 10 carbon atoms, or from 1 to 6 carbon atoms if used alone or in combination with other terms such as “alkoxy”, “arylalkyl”, “haloalkyl”, and “alkylamino” unless specified otherwise. 1 to 20 carbon atoms, 1 to 10 carbon atoms, or the alkyl group can be substituted by other substituents at certain carbon positions. By way of example, the alkyl group may include methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl, dodecyl, and isomers thereof, but the present disclosure may not be limited thereto.

Through the present disclosure, the term “alkenyl”, alone or as a part of another group, means a straight, branched, or cyclic hydrocarbon radical having from 2 to 12 carbon atoms, from 2 to 20 carbon atoms, from 2 to 10 carbon atoms, or from 2 to 6 carbon atoms, and one or more carbon-carbon double bond. The alkenyl group can be substituted at certain available contact points. By way of example, the alkenyl radical may include ethenyl, propenyl, alryl, butenyl and 4-methylbutenyl, pentenyl, hexenyl, isohexenyl, heptenyl, 4,4-dimethylpentenyl, octenyl, 2,2,4-trimethylpentenyl, nonenyl, decenyl, and isomers thereof, but the present disclosure may not be limited thereto. The terms “alkenyl” and “lower alkenyl” include radicals having “cis” and “trans” orientations or alternatively, “E” and “Z” orientations.

Through the present disclosure, the term “halogen” or “halo” means chlorine, bromine, fluorine, or iodine selected with respect to an independent substance.

Hereinafter, an organic sulfonic acid-based compound, a preparing method of the organic sulfonic acid-based compound, a dopant including the organic sulfonic acid-based compound, a conductive polymer composite including the dopant, and a preparing method of the conductive polymer composite of the present disclosure will be explained in detail with reference to illustrative embodiments, examples, and accompanying drawings. However, the present disclosure may not be limited to the illustrative embodiments, examples, and drawings.

In accordance with a first aspect of the present disclosure, there is provided an organic sulfonic acid-based compound in which an aryl group having a substituent is bonded by a flexible hydrocarbon chain, represented by the following Chemical Formula 1:

Ar(R₃)(R₂)O—R₁—SO₃Z; [Chemical Formula 1]

wherein in Chemical Formula 1,

Ar represents an aryl group,

R₁ represents C₁-C₂₀ alkyl, C₂-C₂₀ alkenyl, halo-C₁-C₂₀ alkyl, halo-C₂-C₂₀ alkenyl, or —(CH₂CH₂O)ₙ,

R₂ and R₃ are independently selected from —H, —OH, —CH₃, —C₆H₅, C₆H₄OCH₃, —OCH₂C₆H₅, C₁-C₂₀ alkyl, C₂-C₂₀ alkenyl, halo-C₁-C₂₀ alkyl, halo-C₂-C₂₀ alkenyl, and —(CH₂CH₂O)ₙ, respectively, provided that R₂ and R₃ are not —H at the same time,

Z represents —H or a metal cation M⁺, and if Z is M⁺, the organic sulfonic acid-based compound has a salt form represented by Ar(R₃)(R₂)O—R₁—SO₃⁻M⁺, and

n represents an integer of 1 or more.

By way of example, n may be in a range of from about 3 to about 8, but the present disclosure may not be limited thereto.

In an illustrative embodiment, if one of R₂ and R₃ is —C₆H₅, —C₆H₄OCH₃, or —OCH₂C₆H₅, the other one may be H, but the present disclosure may not be limited thereto.

In an illustrative embodiment, if one of R₂ and R₃ is —OH, the other one may be —CH₃, —C₆H₅, —C₆H₄OCH₃, —OCH₂C₆H₅, C₁-C₂₀ alkyl, C₂-C₂₀ alkenyl, halo-C₁-C₂₀ alkyl, halo-C₂-C₂₀ alkenyl, or —(CH₂CH₂O)ₙ, but the present disclosure may not be limited thereto.

In an illustrative embodiment, R₁ may be C₁-C₁₂ alkyl, C₂-C₁₂ alkenyl, halo-C₁-C₁₂ alkyl, halo-C₂-C₁₂ alkenyl, or —(CH₂CH₂O)ₙ, but the present disclosure may not be limited thereto.

In an illustrative embodiment, n of —(CH₂CH₂O)ₙ defined with respect to R₁ may be an integer in a range of from about 1 to about 10, from about 1 to about 8, or from about 2 to about 6, but the present disclosure may not be limited thereto.

In an illustrative embodiment, R₁ may be an alkyl group having from about 1 to about 20 carbon atoms, an alkyl group having from about 1 to about 16 carbon atoms, an alkyl group having from about 1 to about 12 carbon atoms, an alkyl group having from about 1 to about 10 carbon atoms, or an alkyl group having from about 1 to about 8 carbon atoms, but may the present disclosure not be limited thereto. By way of example, R₁ may be methyl, ethyl, propyl, butyl, pentyl, hexyl, heptyl, octyl, nonyl, or decyl, or isomers thereof, but the present disclosure may not be limited thereto.

In Chemical Formula 1, R₁ may be, for example C₃-C₁₂ alkyl, C₃-C₁₂ alkenyl, halo-C₃-C₁₂ alkyl, halo-C₃-C₁₂ alkenyl, or —(CH₂CH₂O)ₙ, but the present disclosure may not be limited thereto.

In Chemical Formula 1 representing the organic sulfonic acid-based compound in accordance with the present disclosure, a function of the compound as a dopant to be added to a conductive polymer or the like can be changed depending on a type of R₁, R₂, and R₃. Since compatibility between a polymer to be added and/or a solvent may vary depending on a pH according to a relative ratio of the sulfonic acid and its metallic salt, regulating these factors may be very important in use of the compound as a dopant, a function of the compound as a surfactant, and regulation of properties.

In an illustrative embodiment, R₁ may be an alkyl group having from about 3 to about 10 carbon atoms, but the present disclosure may not be limited thereto. By way of example, R₁ may be propyl, butyl, pentyl, hexyl, heptyl, octyl, nonyl, or decyl, or isomers thereof, but the present disclosure may not be limited thereto.

In an illustrative embodiment, R₂ and R₃ may not be hydrogen at the same time or both of them may not be hydrogen, but the present disclosure may not be limited thereto. To be specific, any one or both of R₂ and R₃ may have various substituents such as a hydroxyl group in addition to hydrogen atoms. The novel organic sulfonic acid-based compound in accordance with the present disclosure can be used as a bi-functional dopant having a function as a dopant of a conductive polymer and a function of molecular recognition.

In an illustrative embodiment, the Ar may be a phenyl group or a naphthyl group, but the present disclosure may not be limited thereto.

In an illustrative embodiment, the halo-C₁-C₂₀ alkyl and the halo-C₂-C₂₀ alkenyl may be fluoro-C₁-C₂₀ alkyl and fluoro-C₂-C₂₀ alkenyl, respectively, but the present disclosure may not be limited thereto.

In an illustrative embodiment, M⁺ may be a metal cation, but the present disclosure may not be limited thereto. By way of example, M⁺ may be a cation of an alkali metal, but the present disclosure may not be limited thereto.

In an illustrative embodiment, the organic sulfonic acid-based compound in accordance with the present disclosure may be represented by the following Chemical Formula 2, but may not be limited thereto:

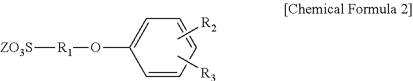

wherein in Chemical Formula 2, R₁, R₂, R₃, and Z are the same as defined in Chemical Formula 1.

In an illustrative embodiment, in Chemical Formula 2, if one of R₂ and R₃ is —C₆H₅, —C₆H₄OCH₃, or —OCH₂C₆H₅, the other one may be H, but the present disclosure may not be limited thereto.

In an illustrative embodiment, in Chemical Formula 2, if one of R₂ and R₃ is —OH, the other one may be —CH₃, —C₆H₅, —C₆H₄OCH₃, —OCH₂C₆H₅, C₁-C₂₀ alkyl, C₂-C₂₀ alkenyl, halo-C₁-C₂₀ alkyl, halo-C₂-C₂₀ alkenyl, or —(CH₂CH₂O)ₙ, but the present disclosure may not be limited thereto.

In an illustrative embodiment, in Chemical Formula 2, R₁ may be C₁-C₁₂ alkyl, C₂-C₁₂ alkenyl, halo-C₁-C₁₂ alkyl, halo-C₂-C₁₂ alkenyl, or —(CH₂CH₂O)ₙ, but the present disclosure may not be limited thereto.

In an illustrative embodiment, in Chemical Formula 2, n of —(CH₂CH₂O)ₙ defined with respect to R₁ may be an integer in a range of from about 1 to about 10, from about 1 to about 8, or from about 2 to about 6, but the present disclosure may not be limited thereto.

In an illustrative embodiment, in Chemical Formula 2, R₁ may be an alkyl group having from about 1 to about 20 carbon atoms, an alkyl group having from about 1 to about 16 carbon atoms, an alkyl group having from about 1 to about 12 carbon atoms, an alkyl group having from about 1 to about 10 carbon atoms, or an alkyl group having from about 1 to about carbon atoms, but the present disclosure may not be limited thereto. By way of example, R₁ may be methyl, ethyl, propyl, butyl, pentyl, hexyl, heptyl, octyl, nonyl, or decyl, or isomers thereof, but the present disclosure may not be limited thereto.

In an illustrative embodiment, in the organic sulfonic acid-based compound of Chemical Formula 2, any one of R₂ and R₃ may be —OH group and the other may be C₁-C₂₀ alkyl or a halo-C₁-C₂ alkyl group, but the present disclosure may not be limited thereto. By way of example, the present disclosure provides an organic sulfonic acid-based compound including a side-chain sulfonic acid, its salt, a hydroxyl group, and a side chain controlling the same. By using a dopant including the compound, a conductive polymer composite having excellent compatibility, heat-resistance, environment-resistance, and conductivity can be prepared.

In accordance with another aspect of the present disclosure, there is provided a preparing method of an organic sulfonic acid-based derivative compound in accordance with the present disclosure, the method including: preparing a precursor solution by dissolving an aromatic precursor having one or more hydroxyl groups to an aryl (Ar) ring in a solvent; and adding a sultone-based compound, or an sulfonic acid-based compound including alkyl having a halogen substituent, alkenyl having a halogen substituent, sulfonate of ethyleneoxy having a halogen substituent, or its metallic salt to the precursor solution to make a reaction therebetween.

The organic sulfonic acid-based derivative compound in accordance with the present disclosure may synthesize a material having one or more hydroxyl groups to an aromatic ring as its precursor and sultone, an organic metal, or alkyl sulfonate having halogen such as bromine at its end through a substitution reaction.

In an illustrative embodiment, the precursor may include phenol, hydroquinone, cresol, resorcinol, or hydroxyl biphenyl, but the present disclosure may not be limited thereto.

In an illustrative embodiment, the solvent may include a member selected from DMF, water, and NMP, but the present disclosure may not be limited thereto.

In an illustrative embodiment, the sultone-based compound may be sultone including an alkyl group having from 1 to 20 carbon atoms, but the present disclosure may not be limited thereto. By way of example, the sultone-based compound may be sultone including an alkyl group having from about 1 to about 20 carbon atoms, an alkyl group having from about 1 to about 16 carbon atoms, an alkyl group having from about 1 to about 12 carbon atoms, an alkyl group having from about 1 to about 10 carbon atoms, or an alkyl group having from about 1 to about 8 carbon atoms, but the present disclosure may not be limited thereto. By way of example, the sultone-based compound may include methane sultone, ethane sultone, propane sultone, butane sultone, pentane sultone, hexane sultone, heptane sultone, octane sultone, nonane sultone, or decane sultone, but the present disclosure may not be limited thereto.

In accordance with still another aspect of the present disclosure, there is provided a dopant including the organic sulfonic acid-based compound represented by Chemical Formula 1 in accordance with the present disclosure.

The dopant including the organic sulfonic acid-based compound of the present disclosure is provided to solve a problem of a conventional dopant of a conductive polymer. The conventional dopant disappears by thermal diffusion or sublimation, and during a process, if time passes at a high temperature, conductivity is sharply decreased or compatibility with respect to a conductive polymer is low, so that electrical conductivity and a mechanical property cannot be improved. Thus, there is provided a dopant in which a sulfonic acid is flexibly bonded to an aryl group such as a benzene ring. In the present disclosure, the reason why the dopant having a flexible bond is prepared is to provide protons while maintaining stacking between an aryl ring such as a benzene ring of a dopant and an aromatic ring of a conductive polymer or a hydrogen bond with a substituent, and a structure of a mesophase, i.e. to effectively perform doping. To be specific, the dopant in accordance with the present disclosure induces a molecular interaction with a conductive polymer, thereby giving a heat-resistance, an environment-resistance, and surface activity. Based on them, a conductive polymer composite having excellent electrical, optical, and mechanical properties can be provided.

In an illustrative embodiment, the organic sulfonic acid-based compound may include a mixture of the organic sulfonic acid with a metallic salt of the organic sulfonic acid, but the present disclosure may not be limited thereto.

In an illustrative embodiment, the organic sulfonic acid-based compound may be represented by the following Chemical Formula 2, and the dopant may include a mixture of the organic sulfonic acid where Z of Chemical Formula 2 is —H with a metallic salt of the organic sulfonic acid where Z is a metal cation M⁺, but may not be limited thereto:

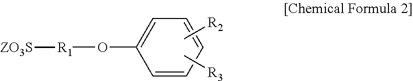

wherein in Chemical Formula 2, R₁, R₂, R₃, and Z are the same as defined above.

In Chemical Formula 1 or 2 representing the organic sulfonic acid-based compound in accordance with the present disclosure, a function of the compound as a dopant to be added to a conductive polymer or the like can be changed depending on a type of R₁, R₂, and R₃. Since compatibility between a polymer to be added and/or a solvent may vary depending on a pH according to a relative ratio of the sulfonic acid and its metallic salt, regulating these factors may be very important in use of the compound as a dopant, a function of the compound as a surfactant, and regulation of properties.

By way of example, if the organic sulfonic acid-based compound of the present disclosure has a metallic salt form, its conjugate base is very important in use of the compound as a dopant. By way of example, the conjugate base may improve solubility and may give surface activity to a composite system with a conductive polymer, and the conjugate base may have a mesophase structure so as to change a shape of a conductive polymer.

In an illustrative embodiment, the dopant may further include an auxiliary dopant selected from the group consisting of camphorsulfonic acid (CSA), dodecylbenzene sulfonic acid (DBSA), acrylamidomethyl sulfonic acid (AMPSA), p-toluene sulfonic acid (PTSA), and combinations thereof, but the present disclosure may not be limited thereto.

In accordance with still another aspect of the present disclosure, there is provided a conductive polymer composite including: a conductive polymer; and a dopant containing an organic sulfonic acid-based compound in accordance with the present disclosure.

In an illustrative embodiment, the conductive polymer may include a member selected from the group consisting of a polyaniline, a polythiophene, a polypyrrole, a polyparaphenylene vinylene, a polyazine, a poly-p-phenylene sulfide, a polyfurane, a polyacetylene, a polyselenophene, and combinations thereof which may have a substituent, but the present disclosure may not be limited thereto.

In an illustrative embodiment, the conductive polymer may include a member selected from the group consisting of a polyaniline, a polypyrrole, a polythiophene, and combinations thereof which may have a substituent, but the present disclosure may not be limited thereto.

In an illustrative embodiment, the conductive polymer may include an emeraldine salt (ES) of a polyaniline, but the present disclosure may not be limited thereto.

In an illustrative embodiment, the conductive polymer may include a polymer blend obtained by mixing an emeraldine salt (ES) of a polyaniline with a second polymer, but the present disclosure may not be limited thereto.

In an illustrative embodiment, the second polymer may include a member selected from the group consisting of a polyethylene, a polypropylene, a polyester, a polyamide, a polyether, a polycarbonate, a polyvinyl acetate, a polyvinylidene fluoride, a polymethylmetacrylate, a polystyrene, a polyvinylchloride, a polyurethane, a polysulfone, a polyethersulfone, a polyether ether ketone (PEEK), a polyimide, an epoxy resin, a polyacrylonitrile, a polyphosphazene, a nitrile butadiene rubber (NBR), a polysiloxane, and combinations thereof, but the present disclosure may not be limited thereto.

In an illustrative embodiment, the conductive polymer composite may have electrical conductivity in a range of from about 10⁻⁹ S/cm to about 10³ S/cm, but the present disclosure may not be limited thereto.

In an illustrative embodiment, the conductive polymer may be in the form of a film, a fiber, a particle or a liquid, but the present disclosure may not be limited thereto.

In accordance with still another aspect of the present disclosure, there is provided a preparing method of a conductive polymer composite, the method including: doping a conductive polymer by adding a solution containing the dopant for a conductive polymer containing the organic sulfonic acid-based compound of the present disclosure.

In an illustrative embodiment, the conductive polymer may be in the form of a solution, a film, a fiber, or a particle, but the present disclosure may not be limited thereto.

In an illustrative embodiment, the preparing method of a conductive polymer composite in accordance with the present disclosure may further include: processing the doped conductive polymer to be in the form of a film, a fiber, or a particle, but the present disclosure may not be limited thereto.

In an illustrative embodiment, the dopant may further include an auxiliary dopant selected from the group consisting of camphorsulfonic acid (CSA), dodecylbenzene sulfonic acid (DBSA), acrylamidomethyl sulfonic acid (AMPSA), p-toluene sulfonic acid (PTSA), and combinations thereof, but the present disclosure may not be limited thereto.

In an illustrative embodiment, the conductive polymer may include a member selected from the group consisting of a polyaniline, a polythiophene, a polypyrrole, a polyparaphenylene vinylene, a polyazine, a poly-p-phenylene sulfide, a polyfurane, a polyacetylene, a polyselenophene, and combinations thereof which may have a substituent, but the present disclosure may not be limited thereto.

In an illustrative embodiment, the conductive polymer may include a member selected from the group consisting of a polyaniline, a polypyrrole, a polythiophene, and combinations thereof which may have a substituent, but the present disclosure may not be limited thereto.

In an illustrative embodiment, the conductive polymer may include an emeraldine salt (ES) of a polyaniline, but the present disclosure may not be limited thereto.

In an illustrative embodiment, the conductive polymer may include a polymer blend obtained by mixing an emeraldine salt (ES) of a polyaniline and a second polymer, but the present disclosure may not be limited thereto.

In an illustrative embodiment, the second polymer may include a member selected from the group consisting of a polyethylene, a polypropylene, a polyester, a polyamide, a polyether, a polycarbonate, a polyvinyl acetate, a polyvinylidene fluoride, a polymethylmetacrylate, a polystyrene, a polyvinylchloride, a polyurethane, a polysulfone, a polyethersulfone, a polyether ether ketone (PEEK), a polyimide, an epoxy resin, a polyacrylonitrile, a polyphosphazene, a nitrile butadiene rubber (NBR), a polysiloxane, and combinations thereof, but the present disclosure may not be limited thereto.

By way of example, when the doping process is performed by adding the dopant to the conductive polymer, the dopant may be dissolved in a solvent and reacted with the conducive polymer in the form of a particle or a solution, or the dopant may be added and reacted during a polymerization reaction of the conductive polymer occurring in an acid solution, or a plastic processing method may be used in a molten state of the conductive polymer, but the present disclosure may not be limited thereto.

In the doping process using the dopant, a polyaniline, a polypyrrole, and a polythiophene in the form of emeraldine bases can be dissolved in various organic solvents and/or acid solutions, and, thus, they can be used in a solution state. As for the conductive polymer in the form of a solid such as a particle, a fiber, a nanotube, and the like, a precipitation method or a conventional plastic processing method can be applied in a dispersed and molten state at a high temperature. The organic solvent used for the doping process in a solution state may include meta-cresol, DMSO (dimethylsulfoxide), DMF (dimethylforamide), NMP (N-methylpyrrolidinone), DMAc (dimethylacetamide), propylenecarbonate, THF, dioxane, or xylene, but the present disclosure may not be limited thereto. As for the doping process in an acid solution, the acid solution may include 80% acetic acid, 60 to 99% formic acid, dichloroacetic acid, or trifluoroacetic acid, but the present disclosure may not be limited thereto. Besides, solvents such as isopropyl alcohol, butoxyethanol, octanol, chloroform, methylethylketone, decalin, and xylene may be used.

In an illustrative embodiment, the conductive polymer may include a polymer blend obtained by mixing an emeraldine salt (ES) of a polyaniline with a second polymer, and the second polymer may include a member selected from the group consisting of a polyethylene, a polypropylene, a polyester, a polyamide, a polyether, a polycarbonate, a polyvinyl acetate, a polyvinylidene fluoride, a polymethylmetacrylate, a polystyrene, a polyvinylchloride, a polyurethane, a polysulfone, a polyethersulfone, a polyether ether ketone (PEEK), a polyimide, an epoxy resin, a polyacrylonitrile, a polyphosphazene, a nitrile butadiene rubber (NBR), a polysiloxane, and combinations thereof, but the present disclosure may not be limited thereto.

In an illustrative embodiment, when the polymer blend obtained by mixing the emeraldine salt (ES) of the polyaniline with the second polymer is used, a dopant design may have different effects between the case of selecting a polymer, as the second polymer, which can be mixed with the ES well and the case of selecting a polymer which is not mixed at all. If the second polymer is a molecular polymer which is mixed well, when blended, dispersibility can be increased and structural uniformity can be maintained. If the second polymer is a polymer which is not mixed well, even if only the ES sufficient to form a continuous phase in the ES/second polymer blend and exceed a percolation limit is used, high conductivity can be obtained, and, thus, it can be expected to have double effect of high conductivity at a small amount of the ES.

In an illustrative embodiment, the conductive polymer composite may have electrical conductivity in a range of from about 10⁻⁹ S/cm to about 10³ S/cm, but the present disclosure may not be limited thereto.

In an illustrative embodiment, the preparing method of a conductive polymer composite may further include: mixing a functional organic acid as an auxiliary dopant with the dopant of the present disclosure, and the functional organic acid may include a member selected from camphorsulfonic acid (CSA), dodecylbenzene sulfonic acid (DBSA), acrylamidomethyl sulfonic acid (AMPSA), and p-toluene sulfonic acid (PTSA), but the present disclosure may not be limited thereto. If the functional organic acid as an auxiliary dopant is mixed and used with the dopant of the present disclosure, main properties such as solubility, processability, and a mechanical property can be controlled more effectively.

In an illustrative embodiment, the conductive polymer may be selected from the forms of a thin film, fiber, particles, and a solution, but the present disclosure may not be limited thereto.

In Chemical Formula 1 or 2 representing the organic sulfonic acid-based compound, a function can be changed depending on a type of R₁, R₂, and R₃. Since a pH and compatibility may vary depending on a relative ratio of a sulfonic acid and its metallic salt, regulating these factors may be very important for a dopant, a surfactant, and regulation of properties. By way of example, if a content, i.e. a molar amount, of the sulfonic acid is equal to or more than a half molar amount of a repeating structure of polyaniline EM, heavy doping is carried out, if equal to or less than the half molar amount, light doping is carried out. Further, if a content of a metallic salt is increased to 2% or more, a hydrophilic surface activity can be imparted. A molar ratio of the sulfonic acid and the metallic salt can be in a range of from about 0.99 to about 0.01, and the content of the sulfonic acid can be affected by whether or not there is an auxiliary dopant. If the content of the sulfonic acid containing an auxiliary dopant includes two sulfonic acid groups per four polyaniline EB benzene rings, as the amount of the metallic salt is increased, dispersity can be increased.

Hereinafter, the present disclosure will be explained in more detail with reference to examples, but the present disclosure may not be limited thereto.

### MODE FOR CARRYING OUT THE INVENTION

As solvents used in the present example, HCl, NH₄OH and H₂SO₄, THF, and TFA were reagents typically used, NaH, NaHCO₃, and potassium tert butoxide were reagent purchased, and chloroform was an extra pure reagent used as produced by Aldrich. As reagents used in a reaction, aniline, ammonium persulfate, 2-aminophenol, p-toluene sulfonic chloride, and (1S)-(+)-10-camphorsulfonic acid were extra pure reagents used as produced by Aldrich.

An IR instrument used for confirming a chemical structure of a compound was NICOLET system 800 and a UV instrument was Jasco V-570. For measuring a thickness, Tencor P-10 super surface profiler was used, and for manufacturing a spin coating film, a spin coater produced by HEADWAY RESERCH Inc. was used.

For measuring viscosity of a polymer, an Ubbelohde viscometer produced by Cannon Inc. was used and viscosity was measured at 30° C. For measuring electrical conductivity of a polymer film, a Source-Measure Units Model 237 produced by Keithley Instruments was used. TGA and DSC used for thermal analysis were TA TGAQ50 and DSCQ10, respectively. For particle size analysis, FPAR-1000 produced by Phota. For elementary analysis, Flash EA1112 produced by CE Instruments was used.

### Example 1

### Synthesis of Organic Sulfonic Acid-Based Compounds (Dopant I, Dopant II, and Dopant III)

0.26 M of each m-cresol, hydroquinone, and 5-methyl resorcinol (Orcinol) was independently added to ethanol separately prepared. 0.26 M potassium-tert-butoxide was dissolved in ethanol, and this solution was mixed with each of the m-cresol, hydroquinone, and 5-methyl resorcinol dissolved in the ethanol with stirring. Then, 0.26 M 1,3-propane sultane was dripped and added thereto so as to respectively prepare organic sulfonic acid-based solid compounds in the form of a salt. The prepared solids were obtained by filtering the solids with a filter. An ion exchange resin (Amberlite IR-120) treated with a 3 N HCl solution was packed, and the obtained solids were dissolved in distilled water and then treated with the ion change resin. While the organic sulfonic acid-based solid compounds in the form of a salt passed through a column of the ion exchange resin, it was converted into an organic sulfonic acid-based compound in the form of an acid. By removing the remaining distilled water through pressurized evaporation and freeze drying, an organic sulfonic acid-based compound derived from the m-cresol (hereinafter, referred to as “dopant I”), an organic sulfonic acid-based compound derived from the hydroquinone (hereinafter, referred to as “dopant II”), and an organic sulfonic acid-based compound derived from the 5-methyl resorcinol (hereinafter, referred to as “dopant III”) represented by Chemical Formulas 3 to 5, respectively, were obtained:

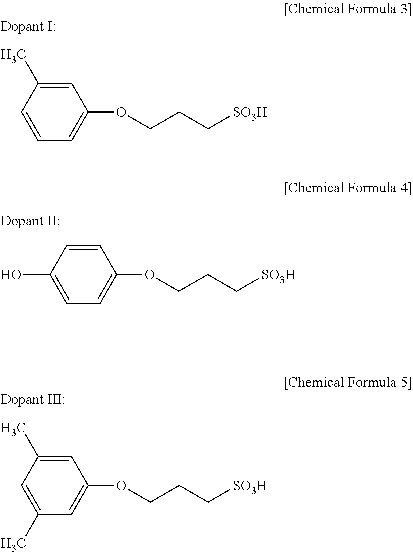 [SMILES: Cc1cccc(OCCCS(=O)(=O)O)c1 ; O=S(=O)(O)CCCOc1ccc(O)cc1 ; Cc1cc(C)cc(OCCCS(=O)(=O)O)c1]

### Example 2

### Synthesis of Organic Sulfonic Acid-Based Compounds (Dopant IV, Dopant V, and Dopant VI)

0.26 M of each 4-phenyphenol, 4-benzyloxyphenol, and methylhydroquinone was independently dissolved in ethanol. 0.26 M potassium-tert-butoxide was dissolved in ethanol, and this solution was mixed with each of the 4-phenyphenol, 4-benzyloxyphenol, and methylhydroquinone dissolved in the ethanol with stirring. Then, 0.26 M 1,3-propane sultane was dripped and added thereto so as to respectively prepare organic sulfonic acid-based solid compounds in the form of a salt. The prepared solids were filtered with a filter, and then dopants were obtained in the same manner as Example 1.

Organic sulfonic acid-based compounds derived from the 4-phenyphenol, 4-benzyloxyphenol, and methylhydroquinone were referred to as dopants IV, V, and VI represented by Chemical Formulas 6 to 8, respectively:

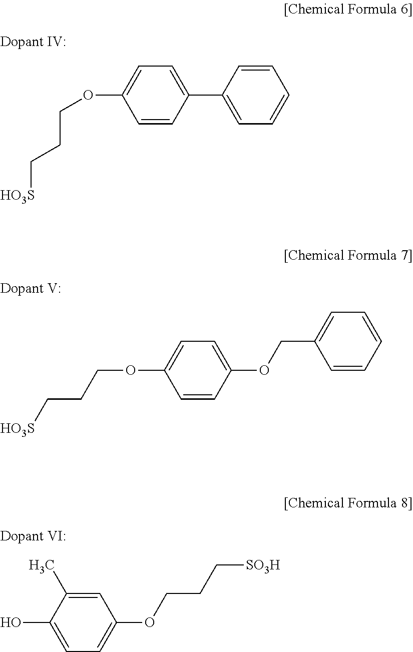 [SMILES: O=S(=O)(O)CCCOc1ccc(-c2ccccc2)cc1 ; O=S(=O)(O)CCCOc1ccc(OCc2ccccc2)cc1 ; Cc1cc(OCCCS(=O)(=O)O)ccc1O]

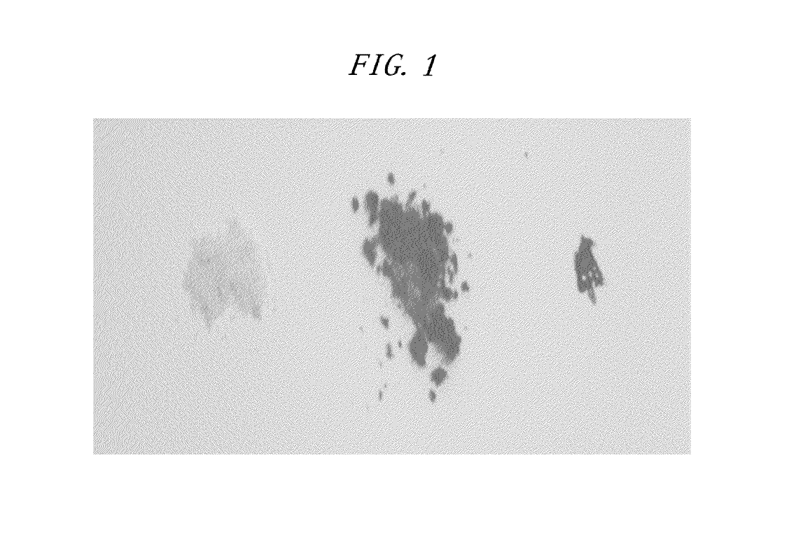

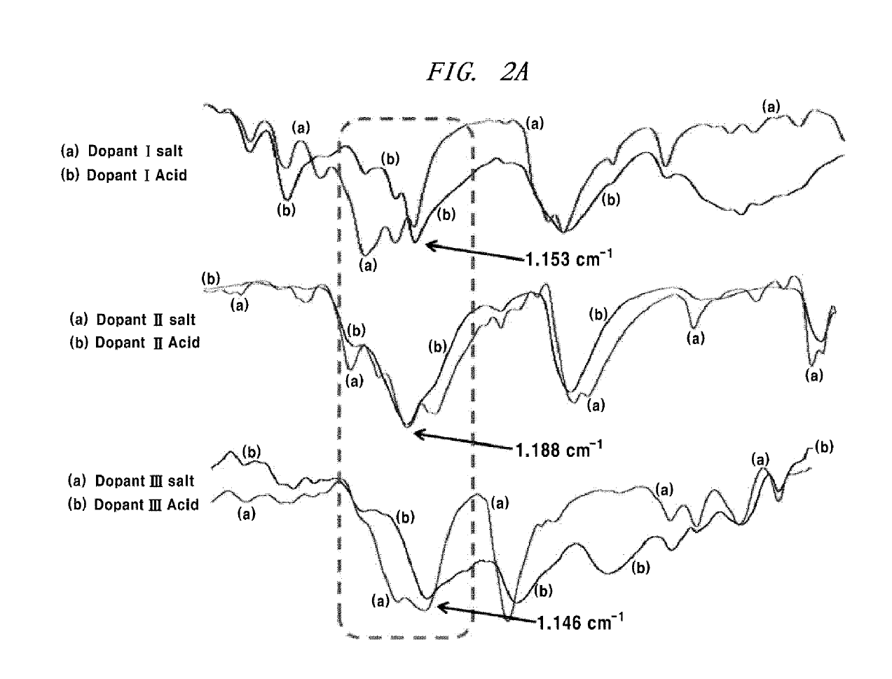

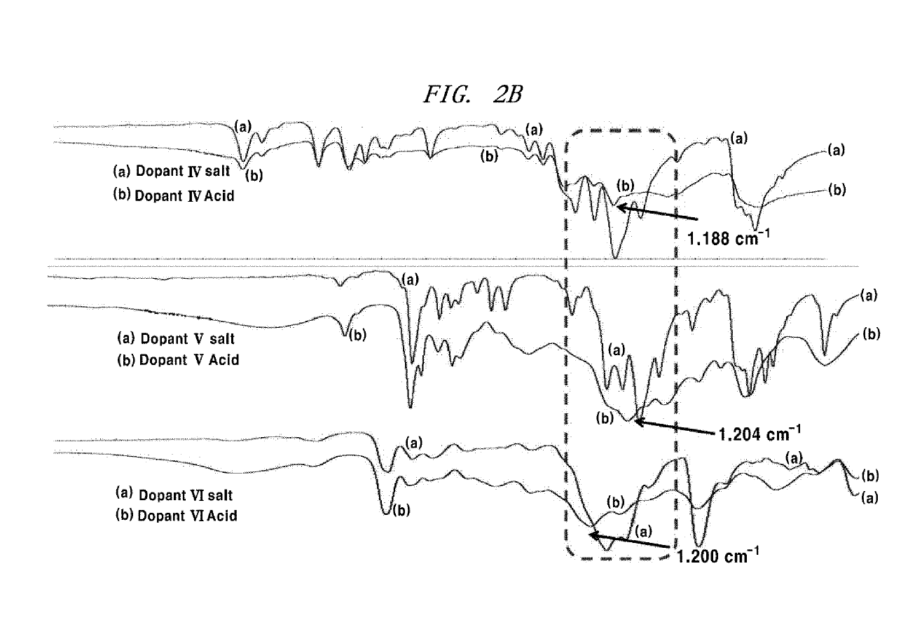

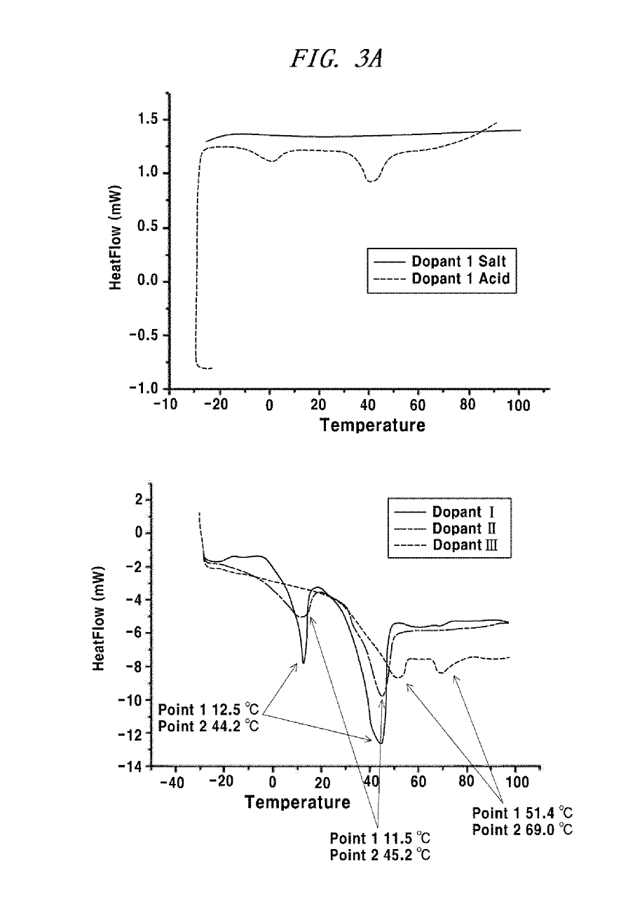

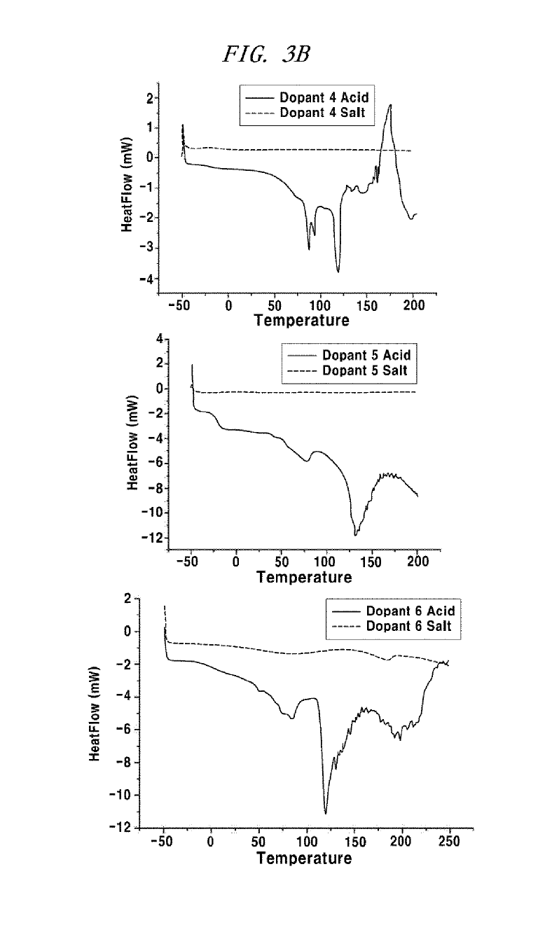

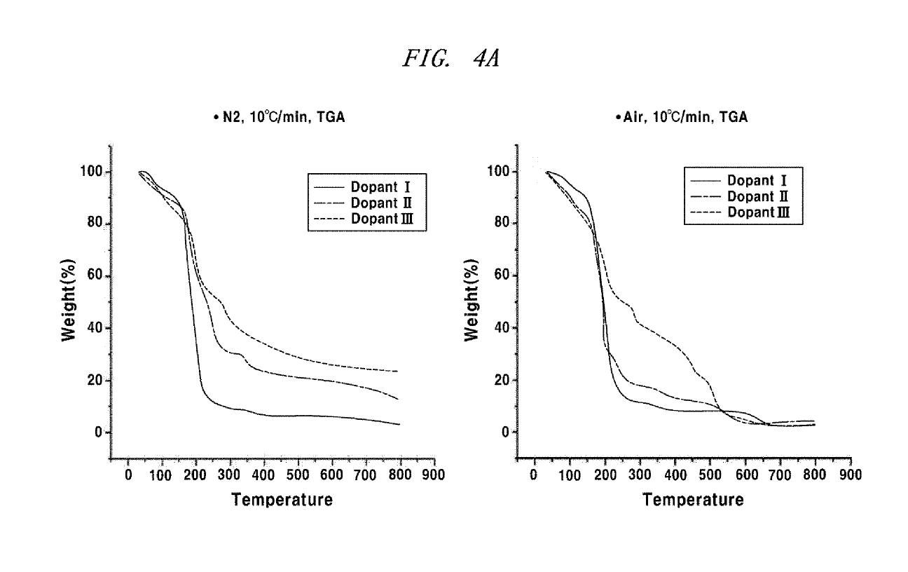

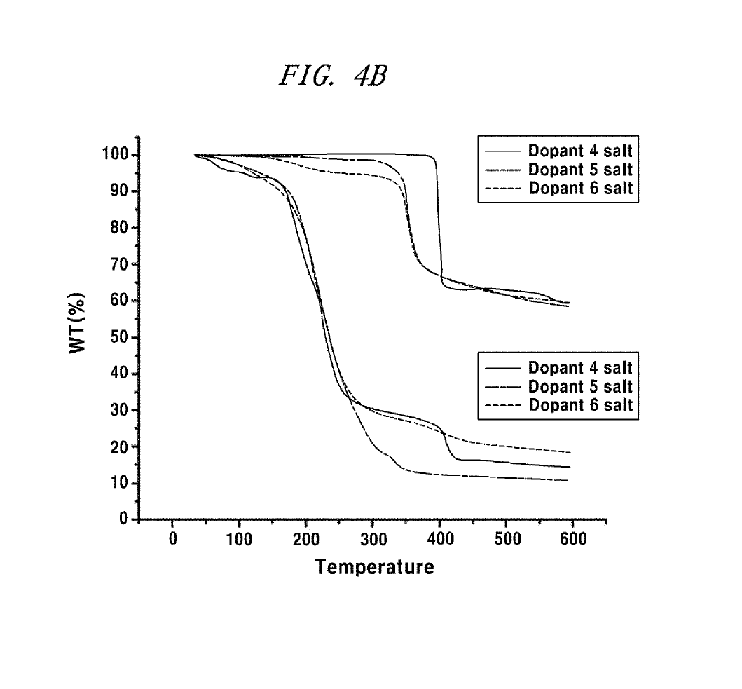

With respect to each of the obtained organic sulfonic acid-based compounds (dopants I to VI), data of a sample photo (FIG. 1), IR (FIGS. 2A and 2B), DSC (FIGS. 3A and 3B), and TGA (FIGS. 4A and 4B) are shown in the drawings, and measurement results of conductivity of doped conducive polymers (Table 1 to Table 3), solubility in various solvents (Table 4), pH (Table 6), transmittance (Table 5), and the like are shown in the following Tables.

### Preparation Example 1

### Synthesis of Polyaniline (PANI)

After a cooling circulation device was installed in a 1000 mL double jacket reactor, a reaction temperature of the reactor was set to 20° C. Then, 800 mL of 4 N HCl and 400 mL of chloroform were put into the reactor and cooled to the set reaction temperature with stirring. 20 g of purified aniline was added to the mixture of the hydrochloric acid with the chloroform and dispersed for about 30 to about 35 minutes. Thereafter, a solution in which 11.44 g of ammonium persulfate was dissolved in 200 mL of 4 M HCl was put into the reactor in which the aniline was dispersed, and a polymerization reaction was carried out until the reaction solution was changed from blue to dark blue.

After the polymerization reaction was completed, the reaction solution was filtered with a 2 μm filter paper and a Büchner filter and washed with distilled water and methanol, and a precipitate was obtained. Then, it was put into 800 mL of 0.1 M NH₄OH and dedoped with stirring for 24 hours.

After the stirring, it was filtered and dried in a vacuum oven fixed at 50° C. for 48 hours, and black polyaniline emeraldine base (EB) was obtained.

Measurement of Viscosity (I.V.) of Polyaniline Emeraldine Base (EB)

In order to measure viscosity of the synthesized polymer, 10 mg of polyaniline (EB) was dissolved in 10 mL of a concentrated sulfuric acid for about 30 hours so as to prepare a polymer standard solution. Viscosity (I.V.) of the prepared polymer standard solution was measured at 30° C. by using “Ubbelohde viscometer”.

Before the viscosity of the polymer solution was measured, viscosity of the concentrated sulfuric acid was first measured at 30° C. so as to be used as a reference value for viscosity measurement. After the polymer solution and the concentrated sulfuric acid as a reference solvent were immersed in a thermostat for about 1 hour for stabilizing a measurement temperature, the viscosity was measured.

$${η}_{inh} = \frac{ln ( η / {η}_{s} )}{c}$$

ηᵢₙₕ: Initial viscosity η: Viscosity of solution

ηₛ: Viscosity of solvent c: Concentration.

### Example 3

### Preparation of Polyaniline (ES)/Dopant Solution

Before a polyaniline film was manufactured, a polyaniline (ES) solution was prepared as follows. In order to prepare polyaniline (ES) solutions respectively doped with the dopant I to the dopant VI, a molar ratio of a polyaniline (EB) tetramer unit to each of the dopant I to the dopant VI was set to 1:2 and a total content of them was set to 1.5 wt. % with respect to m-cresol as a solvent. A mixture of the polyaniline (EB) with each of the dopant I to the dopant VI was uniformly grounded and mixed in a mortar for 30 minutes. The mixture powder was put into each of solvents NMP and m-cresol and dissolved at a speed of 24,000 rpm for 10 minutes by using a homogenizer. Each of the prepared solutions was put on a glass plate on a hot plate set to from 40° C. to 50° C. and dried for 48 hours or more so as to manufacture a film. The glass plate (2.5 cm×2.5 cm×0.1 cm) was immersed in aqua regia for 4 hours or more and then taken out to wash a surface thereof with secondary distilled water and ethanol before use.

Then, with respect to each film prepared, conductivity and sheet resistance were measured and results thereof are as shown in the following Tables 1 to 3.

The conductivity was measured by using a four-point probe method in order to remove contact resistance between a gold wire electrode and a sample. The film and the gold wire were brought into contact with each other by using carbon paste. A thickness of the film was measured by using a micrometer produced by Mitutoy.

A current and a voltage were measured by using a Source-Measure Units Model 237 produced by Keithley Instruments. According to the measurement method, when a constant source current (I, DC) was applied to two outside terminals, a voltage difference (V) caused by the application was measured at the two inside terminals. At the time of measurement, by using a range in which was linearly increased at a source current double of 100 μA, 1 mA, or 10 mA as a reference, a voltage difference measured at a source current of 200 μA, 2 mA, or 20 mA was compared with the reference.

Electrical conductivity was calculated by using the following formula.

$$σ = \frac{( l ) ( I )}{( d \times t ) ( V )}$$

σ: Electrical conductivity (S cm⁻¹, reciprocal of Q cm)

I: Constant source current (DC) (A) applied to sample

V: Voltage (V) measured when constant source current is applied

t: Film thickness (cm)

l: Length between electrodes

d: Length of film in contact with terminal (Film width).

When electrical conductivity of a very thin sample such as a semiconductor wafer or a conductive coating was measured, the measurement was carried out by using a collinear four-point probe method.

A collinear four-point probe was purchased from Jandel Engineering Ltd. and used. This probe was connected to the Source-Measure Units Model 237 produced by Keithley Instruments. The measurement was carried out in the same manner as the four-probe method, and a calculation formula was as follows.

$$σ ( S \text{/} cm ) = ( \frac{ln 2}{π} ) ( \frac{I}{V \times t} )$$

σ: Electrical conductivity (S cm⁻¹, reciprocal of Ω cm)

I: Constant source current (DC) (A) applied to sample

V: Voltage (V) measured when constant source current is applied

t: Film thickness (cm)

$$\frac{ln 2}{π} \text{:}$$

Electric field factor (constant) (1/C) generating at four probes.

In Tables 1 to 3, the term “over” described with respect to conductivity means that measurement cannot be made at a conductivity of 10⁻³ S/cm or less, and the term “over” described with respect to sheet resistance means that measurement cannot be made at a sheet resistance of 10⁵Ω or more.

TABLE 1
Conductivity of the conductive polymers doped with the organic
sulfonic acid compounds and sheet resistance in NMP

| | | Conductivity | Sheet Resistance |
|---|---|---|---|
| Dopant | 1.2 μm Filter | (S/cm) | (□/Ω) in NMP |
| I | Mixed for 30 | | — |
| | minutes | | |
| | Not mixed | | 0.248*10⁵→0.146*10⁵ |
| II | Mixed for 30 | | — |
| | minutes | | |
| | Not mixed | | 0.984*10⁵ |
| III | Mixed for 30 | | — |
| | minutes | | |
| | Not mixed | | — |
| CSA | Mixed for 30 | 21.56 | — |
| | minutes | | |
| | Not mixed | | 0.242*10⁵ |

TABLE 2
Conductivity of the conductive polymers doped with the organic
sulfonic acid-based compounds and sheet resistance in m-cresol

| | | Conductivity | Sheet Resistance |
|---|---|---|---|
| Dopant | 1.2 μm Filter | (S/cm) | (□/Ω) in m-cresol |
| I | Mixed for 30 | 59.66 | 0.379*10¹ |
| | minutes | | |
| | Not mixed | OVER | 0.359*10² |
| II | Mixed for 30 | OVER | OVER |
| | minutes | | |
| | Not mixed | OVER | 0.574*10³ |
| III | Mixed for 30 | OVER | OVER |
| | minutes | | |
| | Not mixed | 1.3 | OVER |

TABLE 3
Conductivity of CSA + dopant in m-cresol

| Sample | | | |
|---|---|---|---|
| (100817 | | | |
| EB_4 | | Conductivity | |
| 25 S/cm) | | (S/cm) | Remarks |
| I | CSA + | 179 | 0.03645 V, 15.32 μm |
| | dopant_I | | |
| | (10%) | | |
| II | CSA + | 211 | 0.0146 V, 32.35 μm; |
| | dopant_II | | Thickness is doubled as |
| | (10%) | | compared with dopants I |
| | | | and III, and V value is |
| | | | equivalent to that of |
| | | | the CSA sample. |
| III | CSA + | 247 | 0.02515 V, 16.08 μm |
| | dopant_III | | |
| | (10%) | | |
| CSA | CSA | 247 | 0.01535 V, 26.3 μm |

### Comparative Example 1

### Preparation of Polyaniline/Camphorsulfonic Acid (ES/CSA) Solution

A solution was prepared by using, instead of the dopants I to VI in Examples, camphorsulfonic acid CSA [(1S)-(+)-10-camphorsulfonic acid 99%, purchased from Aldrich] at the same molar ratio.

### Example 4

### Synthesis of Organic Sulfonic Acid-Based Compound R₁=—(CH₂)₆

81 g of anhydrous dibromohexane was dissolved in 120 mL of EtOH and 50 mL of water, and 50 mL of an aqueous solution in which 12.5 g of sodiumsulfite was dissolved was dripped and added thereto for 2 hours under reflux. After a further reflux for 2 hours and cooling, an unreacted material was removed and a remaining solution was distilled under reduced pressure and concentrated. Through crystallization and precipitation at room temperature, 11.1 g of a colorless prism compound was obtained: yield of 41%.

### Experimental Example 1

### Solubility, Transmittance, and Particle Size Property of Polyaniline Doping Solutions

Solubility properties of polyaniline ES in various organic solvents using the dopants of Examples were compared and checked in the same experimental conditions. As shown in Table 4, solubilities were different depending on a characteristic of a counter ion, and at an equivalent solubility, external appearances were different. After a basket mixing process, transmittances were measured and an average particle size was measured by using a particle size analyzer, and measurement results are as shown in Table 5.

TABLE 4
Solubility of the organic sulfonic acid-based dopants

| | | | isopropyl | | | | | | |
|---|---|---|---|---|---|---|---|---|---|
| | H₂O | MeOH | alcohol | NMP | BuO—EtOH | m-cresol | MEK | CHCl₃ | toluene |
| I | +++ | +++ | +++ | ++ | ++ | ++ | + | − | − |
| II | +++ | +++ | ++ | +++ | +++ | ++ | + | − | − |
| III | +++ | +++ | +++ | +++ | +++ | ++ | + | − | − |
| | | | (slowly) | | | (slowly) | | | |
| IV | +++ | +++ | + | +++ | + | +++ | + | − | − |
| | | | | | | (heating) | | | |
| V | +++ | +++ | ++ | +++ | +++ | ++ | ++ | − | − |
| | | | | | | (heating) | | | |
| VI | +++ | +++ | +++ | +++ | +++ | ++ | + | − | − |
| | | | (slowly) | | | (slowly) | | | |

+++: dissolved well
++: almost dissolved, but not completely dissolved and somewhat precipitated
+: opaquely dispersed
−: not dissolved but precipitated

TABLE 5
Transmittance (UV) of the organic sulfonic acid-based compounds

| | After basket | |
|---|---|---|
| Dopant | treatment | PSA |
| I | 82.0% | 106 nm |
| II | 84.2% | 330 nm |
| III | 70.0% | 420 nm |

### Experimental Example 2

### pH of Organic Sulfonic Acid-Based Compounds

In order to confirm a doping function of the dopants of Examples, pH of a doping solution was checked by using a 0.1 N KOH solution. As a result (Table 6), when the dopants I, II, and III of Examples were converted into 86%, 85%, and 71% sulfonic acids, respectively, all of them had a pH of less than 2. Therefore, a function as a dopant could be confirmed.

TABLE 6
pH of the organic sulfonic acid-based compounds

| Dopant | Titration (Acidity) 0.1N KOH |
|---|---|
| I | 86% |
| II | 85% |
| III | 71% |

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. An organic sulfonic acid-based compound in which an aryl group having a substituent is bonded by a flexible hydrocarbon chain, represented by the following Chemical Formula 1:
Ar(R₃)(R₂)O—R₁—SO₃Z; [Chemical Formula 1]
wherein in Chemical Formula 1,
Ar represents an aryl group,
R₁ represents C₁-C₂₀ alkyl, C₂-C₂₀ alkenyl, halo-C₁-C₂₀ alkyl, halo-C₂-C₂₀ alkenyl, or —(CH₂CH₂O)ₙ,
R₂ and R₃ are independently selected from —H, —OH, —CH₃, —C₆H₅, —C₆H₄OCH₃, —OCH₂C₆H₅, C₁-C₂₀ alkyl, C₂-C₂₀ alkenyl, halo-C₁-C₂₀ alkyl, halo-C₂-C₂₀ alkenyl, and —(CH₂CH₂O)ₙ, respectively, provided that R₂ and R₃ are not —H at the same time,
Z represents —H or a metal cation M⁺, and if Z is M⁺, the organic sulfonic acid-based compound has a salt form represented by Ar(R₃)(R₂)O—R₁—SO₃ M⁺, and
n represents an integer of 1 or more.

2. The organic sulfonic acid-based compound of claim 1,
wherein both of R₂ and R₃ are not —H.

3. The organic sulfonic acid-based compound of claim 1,
wherein if one of R₂ and R₃ is —C₆H₅, —C₆H₄OCH₃, or —OCH₂C₆H₅, the other one is H.

4. The organic sulfonic acid-based compound of claim 1,
wherein the Ar is a phenyl group or a naphthyl group.

5. The organic sulfonic acid-based compound of claim 1,
wherein the halo-C₁-C₂₀ alkyl and the halo-C₂-C₂₀ alkenyl are fluoro-C₁-C₂₀ alkyl and fluoro-C₂-C₂₀ alkenyl, respectively.

6. The organic sulfonic acid-based compound of claim 1,
wherein M⁺ is a cation of an alkali metal.

7. The organic sulfonic acid-based compound of claim 1,
wherein the organic sulfonic acid-based compound is represented by the following Chemical Formula 2: 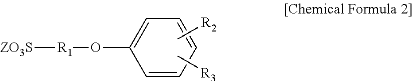
wherein in Chemical Formula 2, R₁, R₂, R₃, and Z are the same as defined in claim 1.

8. A dopant comprising an organic sulfonic acid-based compound of as claimed in claim 1.

9. The dopant of claim 8,
wherein the organic sulfonic acid-based compound includes a mixture of the organic sulfonic acid with a metallic salt of the organic sulfonic acid.

10. The dopant of claim 8,
wherein the organic sulfonic acid-based compound is represented by the following Chemical Formula 2, and the dopant includes a mixture of the organic sulfonic acid where Z of Chemical Formula 2 is —H with a metallic salt of the organic sulfonic acid where Z is a metal cation M⁺: 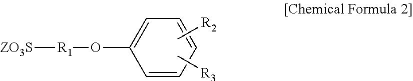
wherein R₁ represents C₁-C₂₀ alkyl, C₂-C₂₀ alkenyl, halo-C₁-C₂₀ alkyl, halo-C₂-C₂₀ alkenyl, or —(CH₂CH₂O)ₙ,
R₂ and R₃ are independently selected from —H, —OH, —CH₃, —C₆H₅, —C₆H₄OCH₃, —OCH₂C₆H₅, C₁-C₂₀ alkyl, C₂-C₂₀ alkenyl, halo-C₁-C₂₀ alkyl, halo-C₂-C₂₀ alkenyl, and —(CH₂CH₂O)ₙ, respectively, provided that R₂ and R₃ are not —H at the same time,
Z represents —H or a metal cation M⁺, and if Z is M⁺, the organic sulfonic acid-based compound has a salt form represented by Ar(R₃)(R₂)O—R₁—SO₃⁻M⁺, and
n represents an integer of 1 or more.

11. The dopant of claim 10,
wherein both of R₂ and R₃ are not —H, wherein if one of R₂ and R₃ is —C₆H₅, C₆H₄OCH₃, or —OCH₂C₆H₅, the other one is H.

12. The dopant of claim 8, further including:
an auxiliary dopant selected from the group consisting of camphorsulfonic acid, dodecylbenzene sulfonic acid, acrylamidomethyl sulfonic acid, p-toluene sulfonic acid, and combinations thereof.

13. A conductive polymer composite, comprising:
a conductive polymer; and
a dopant including an organic sulfonic acid-based compound of claim 1.

14. The conductive polymer composite of claim 13,
wherein the conductive polymer includes a member selected from the group consisting of a polyaniline, a polythiophene, a polypyrrole, a polyparaphenylene vinylene, a polyazine, a poly-p-phenylene sulfide, a polyfurane, a polyacetylene, a polyselenophene, and combinations thereof which may have a substituent.

15. The conductive polymer composite of claim 13,
wherein the conductive polymer includes an emeraldine salt of a polyaniline.

16. The conductive polymer composite of claim 13,
wherein the conductive polymer includes a polymer blend obtained by mixing an emeraldine salt of a polyaniline with a second polymer.

17. The conductive polymer composite of claim 16,
wherein the second polymer includes a member selected from the group consisting of a polyethylene, a polypropylene, a polyester, a polyamide, a polyether, a polycarbonate, a polyvinyl acetate, a polyvinylidene fluoride, a polymethylmetacrylate, a polystyrene, a polyvinylchloride, a polyurethane, a polysulfone, a polyethersulfone, a polyether ether ketone, a polyimide, an epoxy resin, a polyacrylonitrile, a polyphosphazene, a nitrile butadiene rubber, a polysiloxane, and combinations thereof.

18. The conductive polymer composite of claim 13,
wherein the conductive polymer composite has electrical conductivity in a range of from 10⁻⁹ S/cm to 10³ S/cm.

19. The conductive polymer composite of claim 13,
wherein the dopant for a conductive polymer further includes an auxiliary dopant selected from the group consisting of camphorsulfonic acid, dodecylbenzene sulfonic acid, acrylamidomethyl sulfonic acid, p-toluene sulfonic acid, and combinations thereof.

20. The conductive polymer composite of claim 13,
wherein the conductive polymer is in the form of a film, a fiber, a particle, or a liquid.
